(19) United States
(12) Patent Application Publication
(10) Pub. No.: US 2018/0033104 A1
(43) Pub. Date: Feb. 1, 2018

(54) COST-EFFECTIVE METHOD FOR APPLYING FOR OFFICIAL CERTIFICATE

(71) Applicants: Jinglin WANG, Beijing (CN); Heyi WANG, Irvine, CA (US)

(72) Inventors: Jinglin WANG, Beijing (CN); Heyi WANG, Irvine, CA (US)

(21) Appl. No.: 15/706,775

(22) Filed: Sep. 18, 2017

(51) Int. Cl. G06Q 50/18; G06Q 50/26; G06Q 40/06

(52) U.S. Cl. CPC G06Q 50/18; G06Q 40/06; G06Q 50/26

(57) ABSTRACT

A method for applying for an official certificate through a single agency, wherein its local computer server and its foreign computer server are kept communication with each other, between the local computer server and the foreign computer server, there is provided with a time difference reminder and a conference video relay, and/or both the local office and the foreign office have case processing computer management information system which includes event monitor in which whenever receiving a new message, an additional event log is established, while only after the new message has been processed, the additional event log is no longer being remindered regularly. The present invention can keep quality work with lower cost, which benefits clients of both countries, benefits the united agency, and benefits economy of both countries.

### FIELD OF THE PRESENT INVENTION

The present invention is related to a cost-effective method for applying for foreign official certificate on behalf of local clients, i.e. a method for providing local clients a professional service to obtain an official certificate issued from a foreign country authority.

The present invention is also related to a cost-effective method for applying for local official certificate on behalf of foreign clients, i.e. a method for providing foreign clients a professional service to obtain an official certificate issued from the local country authority.

The present invention mainly belongs to a business method.

### PRIOR ART

At this time, if any client wishes to get an official certificate issued from the foreign country, the client usually entrusts the case with a local agency, then the local agency entrusts the case with a foreign agency, then the foreign agency files the case with an authority of the foreign country.

In this case, the client needs to pay service fees for the local agency and to pay service fees for the foreign agency, so the cost of the client remains high. Some clients have to give up their effort to obtain foreign official certificate, so they have to cut their investment plan in the foreign country. This is not good for the local country's economy and for the foreign country's economy.

The expensive service fees are resulted from such a fact that there is no agency who both has qualification to file cases with the local country authority and to file cases with the foreign country authority. The local agency and the foreign agency are two different agencies in two different countries. Both the local country and the foreign country usually have such a policy that only citizen of their own country can be granted qualification to file case with their own government. Some local agency may have a foreign office, but the foreign office can only communicate with the local agency or foreign agency as daily work, but has no power to file any case with the authority of the foreign country. With such kind of foreign office, the cost of the client becomes even higher, not lower. Those skilled in the art have such a bias that it is a normal situation, so no one used to think about how to change the double agency system.

### SUMMARY OF THE PRESENT INVENTION

The object of the present invention is to provide a method for obtaining an official certificate issued from a foreign country through only one agency, which can keep quality work with lower cost, benefits clients of both countries, benefits the united agency, and benefits economy of both countries.

Thus, according to the present invention, there is provided a method for obtaining an official certificate issued from a second country through one agency of a first country, wherein the local agency founds its foreign office in the second country and obtains a qualification to file an application for obtaining the official certificate with the second country's authority, the local agency and the foreign office belong to just the same firm and become a sole agency; the local agency is responsible for communicating with clients, while the foreign office is responsible for communicating with a related foreign authority of the second country.

Preferably, the sole agency charges the clients more than the former local agency used to do (e.g. 130%), so the sole agency has more profit so as to become stronger and keep quality work.

Preferably, the cost of client (e.g. 60%) is designed to be less than the sum of the former local agency and the former foreign agency, so the client pays less than before.

Preferably, the sole agency collects cases from company, university, research institute, or individuals; or the sole agency distributes cases among OEM firms.

Preferably, the sole agency founds an association which consists of members from companies and members from OEM firms.

Preferably, only those companies who prefer quality work to low price with recommend from at least one member from service providing firms can join the association, while only those OEM firms who compete for cases dependent on their quality work, not low price, with recommend from at least one member from companies can join the association.

Preferably, every year, a third party is used to check and evaluate the service of every member of OEM firms, if any member of OEM firms does do quality work, distribute it more cases next year, otherwise, distribute it less cases or even stop to use it next year.

Preferably, said third party is composed of at least 3 independent professionals, any member from OEM firms does not know who are the professionals; and the independent professionals do not know appointed duties each other.

Preferably, the local office, the foreign office, the OEM firms communicate with each other in internet, and/or remote access docket management system, especially with a secret Digital Key.

Preferably, the local office is provided with a local computer server, while the foreign office is provided with a foreign computer server, the local computer server and the foreign computer server are kept communication with each other.

According to the present invention, a single agency can realize duties of the prior art local agency and foreign agency, for at least one attorney of a local office of the single agency can legally have green-card of the foreign country and take and pass registration examination so as to also become the foreign country's attorney, so that the attorney becomes both the local country's attorney and the foreign country's attorney. In this case, any client of the local country or foreign country can use only one agency to apply for a foreign official certificate. In this way, more clients (e.g. 200%) applying for foreign official certificates are available, it is good for the local country's economy, for the single agency for they earn more money, good for the clients for they pay less, and good for the foreign country for more investments are available. That is, the present invention will achieve business success.

According to the present invention, the prior art double agency system is changed to a new sole agency system (i.e. double office system), overturning the bias of those skilled in the art.

The present invention can keep quality work with lower cost. The client can save cost 50-70%, the united agency can 30-50% more income, and both countries can have nearly 200% tax income for issuing a concerned official certificate and more investment, which benefits clients of both countries, benefits the united agency, and benefits economy of both countries.

### BRIEF DESCRIPTION OF ACCOMPANYING DRAWINGS OF THE PRESENT INVENTION

FIG. 1 is a schematic view of prior art system for applying for a foreign official certificate with or without a foreign office in the foreign country.

FIG. 2 is a schematic view of an inventive method for applying for a foreign official certificate according to the present invention.

FIG. 3 is a schematic view of an inventive method for applying for a local official certificate according to the present invention.

FIG. 4A is a schematic view of the united agency network according to the present invention.

FIG. 4B is the main flow chart of the united agency network according to the present invention.

### BEST MODE FOR CARRYING OUT THE PRESENT INVENTION

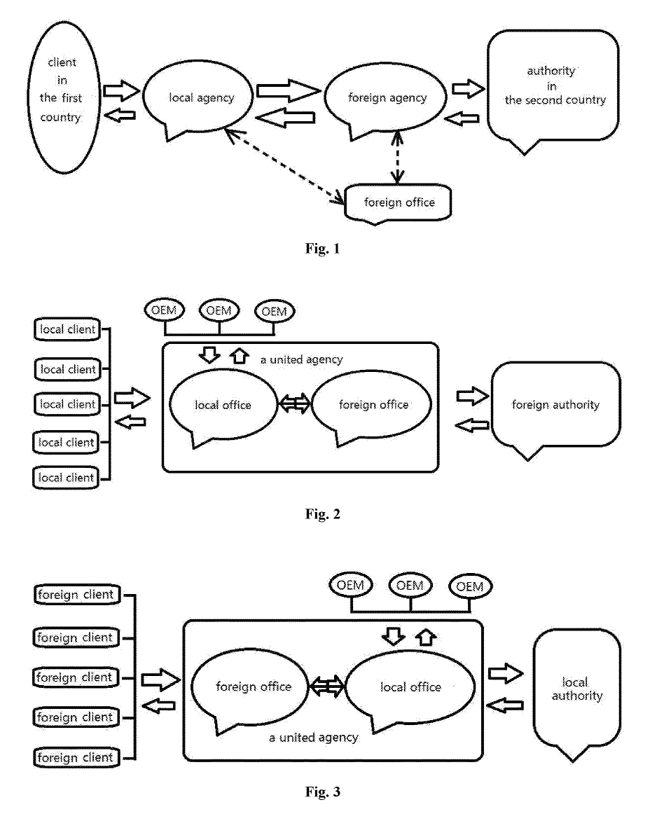

As shown in FIG. 1, in prior art, if any client from the first country wishes to get an official certificate issued from the second country, the client usually entrusts the case with a local agency in the first country, then the local agency entrusts the case with a foreign agency in the second country, then the foreign agency files the case with an authority of the foreign country. In this case, the client needs to pay service fees for the local agency and to pay service fees for the foreign agency, so the cost of the client remains high. Some clients have given up their effort to obtain the foreign official certificate, so some potential income of the local agency cannot be received, this is not good for the local country's economy. Those clients who no longer applies for the foreign official certificate also have to stop their investment plan in the foreign country, which is not good for the foreign country's economy.

The expensive service fees are resulted from such a fact that there is no agency who is both qualified to file cases with the local country authority and to file cases with the foreign country authority. The local agency and the foreign agency are two different agencies from two different countries. Both the local country and the foreign country usually have such a policy that only citizen of their own country can be granted qualification to file case with their own government. For example, the United States permits US citizen or Green Card holder to practice before USPTO, any Chinese who is not US citizen or has no Green Card is not permitted to take or even pass the registration examination of patent agent. On the other hand, China does not allowed foreigners to become a patent agent of China. In this case, except for a Chinese with Green Card founds a patent firm in US, no one can be both a Chinese patent agent and a US patent agent. Some US patent firms have partners who are Chinese and become US citizen or Green Card holder. Some US patent firms even have Beijing Office or Shanghai Office. However, US companies still have to pay the US patent firms and Chinese associates of the US patent firms. At this time, no one can prove with such a fact that the present invention is obvious.

Some local agency may have a foreign office, but the foreign office can only communicate with the local agency or foreign agency as daily work, but has no power to file any case with the authority of the foreign country. With such kind foreign office, the cost of the client becomes even higher, not lower. For example, any liaison office of a Chinese patent firm is not admitted to practice before USPTO, while any liaison office of a US patent firm has no power to file any patent application with SIPO. In this case, those skilled in the art have such a bias that the double agency system is a normal situation, so no one used to think about how to change the double agency system.

As shown in FIG. 2, according to one embodiment of the present invention, there is provided a method for obtaining a US Letters Patent for a Chinese company through only one patent firm, which is both a Chinese firm and a US firm. The sole patent firm has a Beijing office and a US office, and at least one Chinese patent agent of the single patent firm is also a US patent agent who is qualified to file a patent application with USPTO, the Beijing office and the US office belong to just the same patent firm and become a sole agency; the Beijing office is responsible for communicating with the Chinese company, while the US office is responsible for communicating with USPTO. The patent firm charges the Chinese company 130% compared with the former local agency used to do, so the sole patent firm has more profit so as to become stronger and keep quality work. The cost of the Chinese company is designed to be 60% of the sum of the former local agency and the former foreign agency, so the Chinese company pays less than before. The sole patent firm can collect cases not only from company, but also from university, research institute, or individuals; or the sole patent firm can even use one or more OEM firms to make the cost minimized. The sole patent firm can establish an association in China which consists of members from companies and members from OEM firms, only those companies who prefer quality work to low price with recommend from at least one member from OEM firms can join the association, while only those OEM firms who compete for cases dependent on their quality work, not low price, with recommend from at least one member from companies can join the association. Preferably, every year, a third party is organized to check and evaluate the service of every member of OEM firms, if any member of OEM firms does do quality work, distribute it more cases next year, otherwise, distribute it less cases or even stop to use it next year. Preferably, said third party is composed of at least 3 independent professionals, any member from OEM firms does not know who are the professionals; and the independent professionals do not know appointed duties each other. Preferably, the Beijing office, the US office, the OEM firms communicate with each other in internet, and/or remote access docket management system, especially with a secret Digital Key. Preferably, the Beijing office is provided with a local computer server, while the US office is provided with a foreign computer server, the local computer server and the foreign computer server are kept communication with each other.

According to the present invention, a single patent firm can realize duties of the prior art local agency and foreign agency, for at least one attorney of its Beijing office can legally have US Green-Card and take and pass registration examination so as to also be the US patent attorney, so that the attorney becomes both the Chinese patent agent and the US patent agent. In this case, any client of China can use only one patent firm to apply for a US Letters Patent. In this way, more clients (up to 200% or even more) applying for the US Letters Patent are available, it is good for the patent firm who can earn more money, good for the Chinese clients who pay less, and good for the US for more investments are available. That is, the present invention will achieve business success.

According to the prior art, applying for a US Letters Patent has to be processed by two patent firms, a Chinese patent firm and a US patent firm. Even the Chinese patent firm has done everything, the US patent firm must charge a minimum fee (e.g. USD1650). According to the present invention, however, the double agency system is changed to a new sole agency system (i.e. Beijing office and US office of only one patent firm), overturning the bias of those skilled in the art. The present invention is nonobivious.

As shown in FIG. 3, according to another embodiment of the present invention, there is provided a method for applying a Chinese patent certificate for a US company through only one patent firm, which is both a US firm and a Chinese firm. The sole patent firm has a US office and a Beijing office, and at least one US patent agent of the single patent firm is also a Chinese patent agent who is qualified to file a patent application with SIPO, the US office and the Beijing office belong to just the same patent firm and become a sole agency; the US office is responsible for communicating with the US company, while the Beijing office is responsible for communicating with SIPO. The patent firm charges the US company 30% over the former US local agency used to do, so the sole patent firm has more profit so as to become stronger and keep quality work. The cost of the US company is designed to pay 60% of the sum of the former US local agency and the former China agency, so the US company pays less than before. The sole patent firm can collect cases not only from US company, but also from US university, US research institute, or US individuals; or the Beijing office and/or US office of the sole patent firm can even use OEM firms to make the cost minimized. Preferably, every year, a third party is organized to check and evaluate the service of every member of OEM firms, if any member of OEM firms does do quality work, distribute it more cases next year, otherwise, distribute it less cases or even stop to use it next year. Preferably, said third party is composed of at least 3 independent professionals, any member from OEM firms does not know who are the professionals; and the independent professionals do not know any appointed duties each other. Preferably, the Beijing office, the US office, the OEM firms communicate with each other in internet, and/or remote access docket management system, especially with a secret Digital Key. The US office is provided with a local computer server, while the Beijing office is provided with a foreign computer server, the local computer server and the foreign computer server are kept communication with each other. According to the present invention, a single patent firm can realize duties of the prior art US agency and China agency, for at least one attorney of its US office is also a Chinese patent attorney. In this case, any US client can use only one patent firm to apply for a Patent Certificate in China. In this way, more clients applying for the Patent Certificate in China maybe doubled, it is good for the patent firm who can earn more money, good for the US clients who pay less, and good for the US for having more tax. That is, the present invention will achieve business success in US.

According to the prior art, applying for a Patent Certificate in China has to be processed by two patent firms, a US patent firm and a Chinese patent firm. According to the present invention, however, the double agency system is changed to a new sole agency system (i.e. US office and Beijing office of only one united patent firm), overturning the bias for those skilled in the art. The business method of the present invention is nonobivious.

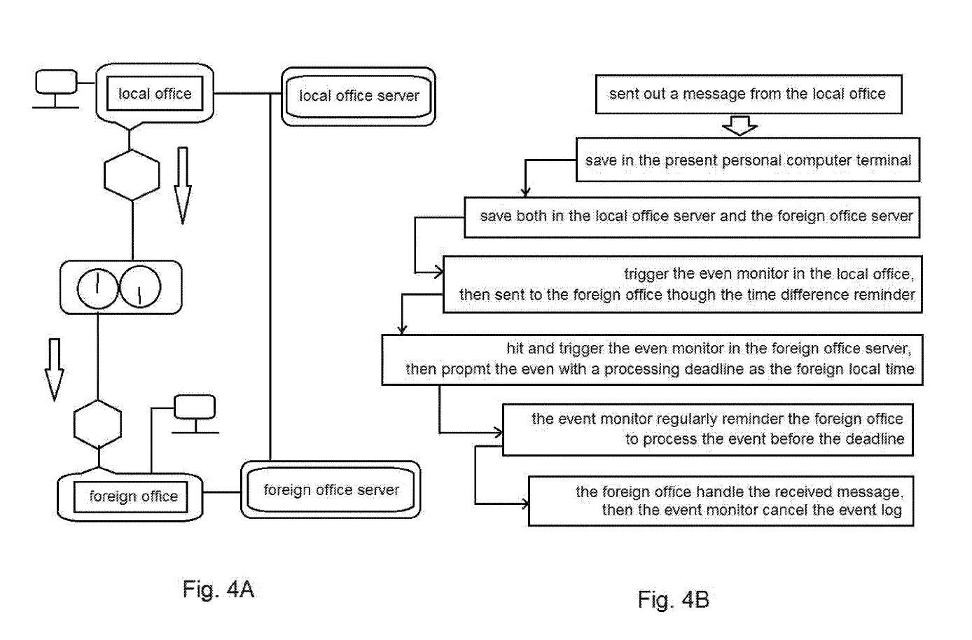

FIG. 4A and FIG. 4B show the united agency network including the layout of the computer systems among the local office and the foreign office, as well as the process of their software working. For example, the Beijing office is provided with a Beijing computer server, while the US office is provided with a US computer server, the Beijing computer server and the US computer server are kept communication with each other.

Both the Beijing office and the US office at least have such apparatus as DPF document converter, paper document scanner, jet laser printer and/or Uninterruptible Power System (UPS).

The Beijing office and the US office have time difference, everyday, when work is over in the US office, the Beijing office is in mid-night; when the last day before any deadline in US office is still in time limit for an event, the deadline of the same event according to the Beijing Office maybe over. In the present invention, between the Beijing computer server and the US computer server, there is provided with a time difference reminder. With the time difference reminder, the deadline of any event in the US office is considered before informing the Beijing office about this event, while the deadline of any event in the Beijing office is considered before informing the US office about this event. In this case, it is impossible that when any event reaches the Beijing Office, only a few hours are left to process the event before its deadline.

When the united agency holds a meeting, to overcome the time difference between the US office and the Beijing office, a conference video relay can be provided in US office and/or the Beijing office. In this way, if a meeting is held in the Beijing Office at 8:00 am Monday of Beijing Time, the US office can also held the same meeting in the US Office at 8:00 am Monday of US local Time. Both the local office and the foreign office have case processing computer management information system (MIS) which includes a event monitor, in which when receiving a new message, an additional event log is established, while only after the new message has been processed, the additional event log is canceled automatically, no longer any reminder is prompted regularly.

With embodiments disclosed above, those skilled in the art can modify, improve or variate the present invention, however, such activities will all fall into the scope of protection defined in the attached Claims.

1. A method for obtaining an official certificate issued from a second country through one agency of a first country, wherein the agency of the first country has its local office in the first country and its foreign office in the second country and obtains a qualification to file an application for obtaining the official certificate with the second country's authority, the local office and the foreign office belong to just the same firm as each other and become a united agency; the local office is responsible for communicating with clients, while the foreign office is responsible for communicating with a related foreign authority of the second country; preferably wherein the local office is provided with a local computer server, while the foreign office is provided with a foreign computer server, the local computer server and the foreign computer server are kept communication with each other, both the local office and the foreign office at least have DPF document converter, paper document scanner, jet laser printer and/or Uninterruptible Power System (UPS), between the local computer server and the foreign computer server, there is provided with a time difference reminder and a conference video relay, and/or both the local office and the foreign office have case processing computer management information system which includes event monitor, in which whenever receiving a new message, an additional event log is established, while only after the new message has been processed, the additional event log is no longer being remindered regularly.

2. The method of claim 1, wherein the united agency charges the clients more than the former local agency used to do, so the united agency has more profit so as to become stronger and keep quality work; and the cost of client is designed to be less than the sum of the former local agency and the former foreign agency, so the client pays less than before; and the united agency collects cases from company, university, research institute, or individuals, or the united agency can distribute cases among OEM firms and work with OEM firms.

3. The method of claim 1, wherein the united agency can found an association which consists of members from companies and members from OEM firms; only those companies who prefer quality work to low price with recommend from at least one member from OEM firms can join the association, while only those OEM firms who compete for cases dependent on their quality work, not low price, with recommend from at least one member from companies can join the association.

4. The method of claim 1, wherein every year, a third party is used to check and evaluate the service of every member of OEM firms, if any member of OEM firms does do quality work, distribute it more cases next year, otherwise, distribute it less cases or even stop to use it next year; said third party is composed of at least 3 independent professionals, any member from OEM firms does not know who are the professionals; and the independent professionals do not know appointed duties each other.

5. The method of claim 4, wherein the local office, the foreign office and the OEM firms communicate with each other in internet, and remote access docket management system with a secret Digital Key.
